(19) United States
(12) Patent Application Publication
(10) Pub. No.: US 2011/0183741 A1
(43) Pub. Date: Jul. 28, 2011

(54) COMBINATION ARCADE GAME AND MERCHANDISE DISPENSER

(76) Inventor: JEFFREY T. SMART, ALTOONA, IA (US)

(21) Appl. No.: 12/691,865

(22) Filed: Jan. 22, 2010

(51) Int. Cl. A63F 9/24; A63F 13/00; A63B 71/00

(52) U.S. Cl. 463/17; 463/25; 463/30; 273/138.3

(57) ABSTRACT

An arcade game with a prize selection and prize delivery system is provided. A pusher-type arcade game includes a prize dispenser and selection mechanism within a single cabinet. A password output is provided to a player at the conclusion of a game session that the player may utilize at a later game session to carryover accumulated points. The accumulated points may be redeemed for prizes within the attached dispenser. Points are earned when coins or tokens are pushed over a ledge. Various mechanisms are described for earning bonus points, and play of the game may include a cumulative jackpot of points that build until it is won. The payout rate of the machine may be controlled by an operator by varying the frequency with which the jackpot is awarded.

### FIELD OF THE INVENTION

This invention relates generally to arcade games and machines for dispensing merchandise for prizes.

### BACKGROUND OF THE INVENTION

Arcade games are known wherein a player accumulates points through play of the game. Typically the player will activate the game by inserting coins, tokens, currency or cards with magnetized strips. It is also known for arcades to offer prizes or merchandise that may be “purchased” by exchanging the points earned playing the game for merchandise. For example, some such games will dispense tickets to a player depending on the number of points accumulated in playing the game by the player. These tickets may then be exchanged for selected merchandise that has been assigned a ticket price. The counting and exchange of tickets may be manual, or may be automated. As an alternative to tickets, the machines may dispense tokens. As a further alternative, the points or credits may be registered and recorded on a medium such as a card with a magnetic strip, or may be printed on a paper receipt.

It is also known to provide a single game that is combined with a prize or merchandise dispenser such that a player who accumulates points playing the game may win various prizes at certain point thresholds. Generally in that instance, a player must accumulate the points in a single session, and cannot combine points won in previous sessions to reach the required thresholds.

One popular style of arcade game is a pusher game. The pusher games drop coins onto a playing field. A reciprocating plate, or other moving part will push accumulated coins toward a ledge or goal. As coins build up on the playing field, the movement of the pusher plate tends to move the coins towards the ledge. As additional coins are added to the playing field by the player, coins will fall off the ledge. According to a common embodiment, the player may retain any of the coins that drop off the ledge. Often times the addition of a single coin can cause multiple coins to drop off of the ledge. Therefore, there is a chance for a player to make a profit on any single play. Additionally, these pusher games may be provided with devices that, to varying degrees, permit a player to aim or guide the coin towards a specific spot on the playing field in order to enhance the chances of multiple coins dropping off the ledge. It is well understood that rather than actual coins circulated as currency specialized tokens may be used. Commonly these tokens will be usable at other machines within a single arcade, and may be redeemable for prizes or cash.

### BRIEF SUMMARY OF THE INVENTION

The present invention improves upon and solves problems related to these arcade games. According to one embodiment, the present invention combines a pusher style game with a prize or merchandise dispenser in a single integrated unit. Therefore, a player playing the pusher game may redeem points accumulated during the pusher game for prizes without leaving the machine, and without the need of help from a third person. According to this embodiment, the coins or tokens used as the game pieces of the pusher game always remain within the machine, and are not dispensed to the player. Instead, the coins are counted as they drop off the ledge to accumulate points for the player, which may be redeemed for prizes from the connected dispenser.

According to another embodiment, the present invention is directed to an amusement machine that includes a game wherein a player can accumulate points by playing the game and a dispenser that will dispense selected merchandise in exchange for the accumulated points. The machine also includes a mechanism for providing a pass code to a player that corresponds with the points accumulated by the player during a first game session. The machine also includes an input mechanism such that the player may return to the machine at a later time and input the pass code in order to add the points accumulated in the first game session with points accumulated in a new game session. Thus, a player may continue to accumulate points towards the purchase or redemption of merchandise within the machine over multiple sessions, in order to win better prizes that have been assigned higher point thresholds.

According to another embodiment, the machine will provide a printed receipt to a player upon termination of a game session. The printed receipt will include the pass code such that the player may use the points accumulated in the first game session in a second game session by entering the pass code from the printed receipt.

According to another embodiment of the present invention, a pusher game is provided. The pusher game includes a playing field whereon coins are accumulated through play of the game. The game includes a reciprocating plate that pushes coins towards an edge. A player accumulates points as coins drop off the ledge. A player plays the game by triggering the release of coins one at a time from an elevated coin release location. Wipers are provided between the coin release location and the playing field in order to permit the player to manipulate the path of a coin as it falls towards the playing field. A moving bonus target is provided between the coin release location and the playing field such that if a released coin falls through the bonus moving target a bonus is earned by the player. Stationary targets that may be randomly illuminated are also provided between the coin release location and the playing field such that if a released coin drops through an illuminated stationary bonus target the player also earns an additional bonus. A video display may be provided as part of the machine.

According to one embodiment, the bonus for a released coin dropping through the moving bonus target is a spin of a video wheel. The video wheel includes several values of bonus points that may be added to a jackpot. The bonus wheel may also include a spot that results in the winning of the jackpot. Preferably the jackpot will be a value of points that is continually accumulated at a single machine and is added to the points of the player playing the game at the time the jackpot is won. Preferably the bonus for passing through an illuminated stationary bonus target will be the release of additional coins onto the playing field.

According to another embodiment, a pusher game is played when a player purchases play credits using coins, tokens, currency, or an electronic credit device, such as a credit card, debit card, or game credit card with a magnetic strip. The game will display the number of credits, which relate directly to the number of coins a player may release. Coins are released from an elevated coin release location and fall towards and eventually onto a playing field. Coins that accumulate on the playing field are pushed towards and eventually over an edge by an oscillating plate. Points are awarded to a player as coins drop off the ledge. The coins are in a closed loop and are cycled back to the elevated coin release location, such that the player never touches the coins used in the play of the game. Points may also be awarded to a player based on the coins falling through various targets as they fall from the coin release location to the playing field. Once a game session is over, the player can use the accumulated points to purchase merchandise from an attached dispenser. Alternatively, the player may request that the machine generate a receipt that will allow the player to save the points and redeem them at a later time. A machine includes an internal data tracking system whereby a code is assigned to the point values won. The player can use the code on the receipt to reactivate the points that correspond with the coded value. Multiple receipts may be entered to combine points, such that a player can win prizes assigned higher point value than have been won in a single session.

### BRIEF DESCRIPTION OF THE DRAWINGS

FIG. 1 is an isometric view of a machine according to one embodiment of the present invention.

FIG. 2 is a front elevation view of the machine of FIG. 1.

FIG. 3 is a schematic representing a cross sectional side view of a pusher game according to one embodiment of the present invention.

FIG. 4 is a block diagram schematic of a combination game and merchandise dispenser machine according to one embodiment of the present invention.

FIG. 5 is a front view of a display screen used when a chance to win the jackpot has been earned according to one embodiment of the present invention.

### DETAILED DESCRIPTION OF THE PREFERRED EMBODIMENTS

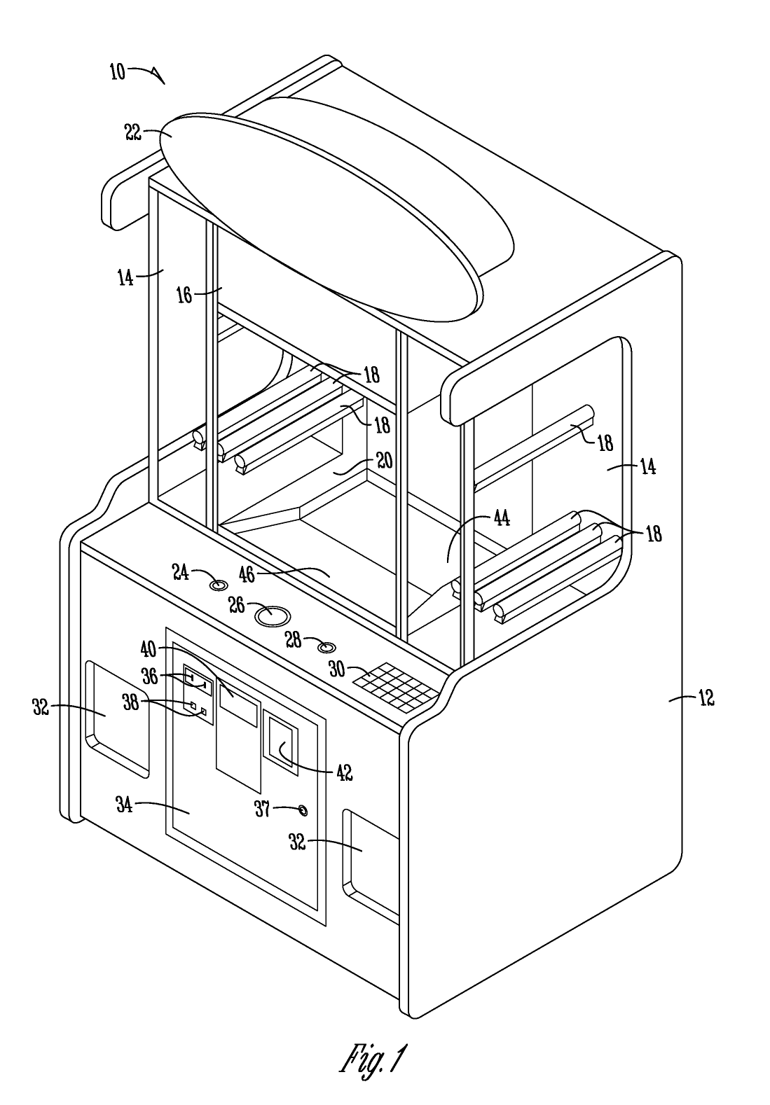

FIG. 1 is an isometric view of a machine 10 that is a combination pusher game and prize dispenser disposed within a cabinet 12. The cabinet 12 includes merchandise compartments 14 located to the left and right of a game compartment 20. A grand prize compartment 16 is provided above the game compartment 20. Spindles 18 are provided within the merchandise compartments 14 to dispense prizes or merchandise (not shown) that can be hung from and displayed on the spindles 18. According to one embodiment, the spindles 18 have a corkscrew shape, and can be axially rotated to dispense prizes or merchandise retained on the spindles 18. Other mechanisms for displaying and dispensing prizes and merchandise will be well known to those of skill in the art. The merchandise compartments 14 and 16 and the game compartment 20 are preferably enclosed in glass, or other transparent dividers such that their contents are readily visible to players and spectators outside the machine 10.

A sign 22 or other decorations may be attached to the cabinet 12 to provide a visually appealing appearance, and to provide information to players and perspective players. The cabinet 12 should be manufactured from hard durable materials such as wood, metal, hard plastic, and laminated or composite materials. The cabinet 12 may be decorated with a theme, such as a sporting event or sporting events, or any other desired theme.

Control buttons 24, 26, and 28 are provided at a front portion of the cabinet 12 to permit a player to interact with and control the game. Preferably the controls 24, 26, and 28 will be at an ergonomically convenient location, such that a player can easily access the controls while viewing the game compartment 20. While the controls 24, 26, and 28 are shown as push buttons, those of ordinary skill in the art will be aware that other control mechanisms may be used, such as levers, dials, track balls, joy sticks, touch pads, and others. A key pad 30, which may be a touch pad or may include individual buttons, is also provided to permit a player to enter information, such as an assigned pass code, into the game. The key pad 30 may also be useful in selecting merchandise or prizes to be dispensed from the merchandise compartments 14. Prize doors 32 are provided on the front of the cabinet 12 to permit a player to retrieve dispensed merchandise or prizes from the cabinet 12. Preferably the prize doors 32 will be biased into the closed position to cover corresponding openings. Also, preferably the prize doors 32, and/or the design of the machine 10 in general, will be such that a person cannot access or tamper with the merchandise stored in the merchandise compartments 14 by gaining access through the prize doors 32.

An access door 34 is mounted to the front of cabinet 12 that covers an access opening that leads to the inner workings of the machine 10. The door 34 includes a secure lock 37 to prevent access to the inside of the machine 10 by unauthorized personnel. In the embodiment shown, several features are mounted to the door 34. These features include coin slots 36, which accept payment in the form of coins, such as quarters, or the slots 36 may lead to equipment that accepts tokens. Coin returns 38 are provided to return coins that are not accepted as payment, or to provide change to a player. A currency intake 40 is included on the door 34 to accept payment in the form of paper currency, such as one, five, ten, or 20 dollar bills. A receipt outlet 42 is provided on the door 34 for printing out a receipt to a player that includes a pass code that corresponds with the points earned by the player. Additional information, such as the machine location, and the date and time may be included on the receipts that are provided through the receipt outlet 42.

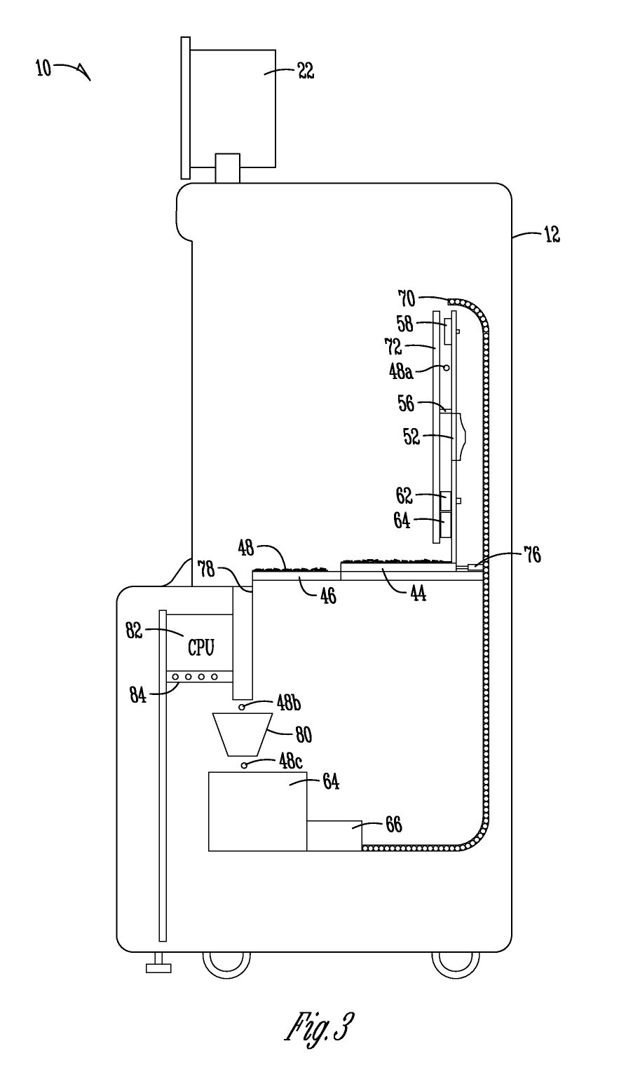

In the embodiment of FIG. 1, the game compartment 20 encloses a coin pusher-type game. Those of skill in the art will be aware of numerous configurations for a coin pusher game. Additionally, many of the features of the present invention may be advantageously used in conjunction with other types of arcade games that may be included in the game compartment 20. In the improved coin pusher game of the preferred embodiment, a reciprocating plate 44 is provided directly above a stationary plate 46. The two plates 44 and 46 form the playing field on which coins or tokens (not shown in FIG. 1) are dropped. The oscillating movement of plate 44, in conjunction with the excess accumulation of coins or tokens, eventually causes the coins or tokens to fall from the oscillating plate 44 onto the stationary plate 46 and eventually off of a ledge at the front of the stationary plate 46. According to the embodiment shown, points are scored as the coins or tokens drop off the front ledge of stationary plate 46. The cycle of the coins or tokens according to a preferred embodiment of the invention is best seen in FIG. 3.

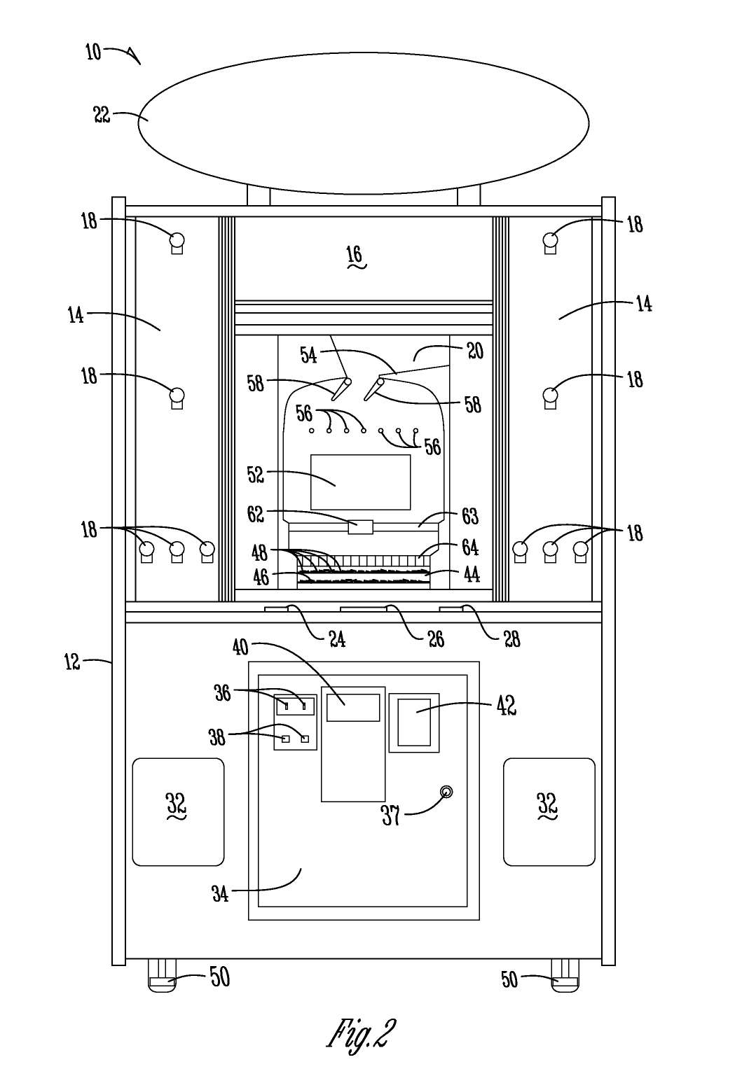

FIG. 2 is a front elevation view of the machine 10 according to FIG. 1, with the coins 48 loaded within the game compartment 20. The machine 10 includes wheels 50 mounted to the bottom of cabinet 12 to aid in moving the machine. The wheels 50 may include locks, may be retractable, or the machine 10 may include extendable feet (not shown) in order to maintain machine 10 in a stable stationary position after it is moved to a desired location. Some of the details of the improved pusher game according to one embodiment of the present invention can be seen within the game compartment 20 of the machine 10 shown in FIG. 2. As seen in FIG. 2, a plurality of coins (or tokens) 48 rest upon the stationary plate 46 and the reciprocating plate 44. A video monitor 52, such as an LCD screen, or other type of monitor, is provided within the game compartment 20. The video monitor 52 receives a signal from a computer processor (not shown in FIG. 2).

To play the game, a user will provide payment to the machine 10 by inserting coins into the coin slots 36, currency into the currency acceptor 40, or by other payment form, such as inserting a credit card, debit card, or dedicated game card that includes a magnetic strip, into a card reader (not shown). This payment will provide the player with a number of credits that corresponds to the number of coins that the player can release to fall onto the reciprocating plate 44. For example, button 26 may be a dedicated play button such that if a player has credits remaining, the player can depress button 26 to release a coin. A released coin enters the playing area by, for example sliding or rolling down ramp 54 located at the upper portion of the game compartment 20. Such a released coin will drop from the ramp 54 eventually onto the reciprocating plate 44. The path of the coin as it falls towards the playing field may be altered by bumpers 56, which introduce randomness into the path that a coin falls. Additionally flippers, or wipers 58 may be provided that can be controlled by a player via button 28 in order for a player to attempt to guide the falling coin along a desired path. Stationary targets 60 may be provided between the ramp 54 and the plates 44 and 46. These stationary targets 60 may be selectively illuminated by the computer processor (not shown) provided within the machine 10. If a falling coin passes through one of the illuminated stationary targets 60 the player may receive a bonus, for example additional credits, or additional coins may be automatically dispensed. A moving target 62 may also be provided between the ramp 54 and the playing formed by the plates 44 and 46. If a falling coin falls through the moving target 62 a player may receive an additional bonus in the form of credits, additional coins, or as in the preferred embodiment, additional points that get added to a cumulative jackpot associated with the machine, or a chance to win the cumulative jackpot.

FIG. 3 is a cross sectional side view of a pusher game according to one embodiment of the present invention. The pusher game is disposed within the cabinet 12 of machine 10. An excess reserve of coins 48 is provided in coin reservoir 64. The coins 48 are moved from the reservoir 64 to a coin lift track 68 by coin loader 66. Those of skill in the art will be aware of various designs and mechanisms suitable for transporting coins from a coin reservoir 64 to the coin release location 70. During play of the game, coins are released one at a time from the coin release location 70. The released coins will drop from the coin release location 70 under the force of gravity. A released coin may roll or slide along a ramp (not shown in FIG. 3) and will be retained between a front barrier 72 and a rear barrier 74 as it falls towards the playing field formed by the reciprocating plate 44 and stationary plate 46. A falling coin 48a is shown within the space between barrier 72 and barrier 74. The falling coin 48a has already passed by flippers 58, and may have had its path changed or diverted by the flippers 58. The falling coin 48a may also encounter and be diverted by bumpers 56. As the falling coin 48a continues on its path to the reciprocating plate 44, it may pass through moving target 62, and will pass through one of the stationary targets 64, before falling onto reciprocating plate 44. The plate 44 is moved in a reciprocating motion by motor 76. As excess coins 48 build up on the reciprocating plate 44, some of them spill over onto stationary plate 46. Eventually, as additional coins build up on stationary plate 46, some of the coins will fall off of ledge 78 at the front of stationary plate 46. A coin 48b is shown falling from ledge 78 towards a coin counter 80 that senses and records the number of coins that fall over ledge 78. From the coin counter 80, the coins are transferred back to the coin reservoir 64 and the cycle is repeated. A coin 48c is shown being transferred from the coin counter 80 to the coin reservoir 64 by falling under the force of gravity. Those of skill in the art will be aware of other mechanisms for transporting the coins to the coin reservoir 64.

A computer processor 82 is provided within the cabinet 12. The computer processor 82 may include an imbedded flash drive. A four-button operator interface 84 may be provided to permit an operator to interact with and customize the game. The video monitor 52 may be used to display operational information when the machine 10 is in an operator maintenance mode. The computer processor 82 may be used to provide commands and operating instructions to the various components of the machine 10 according to embedded logic. The computer processor 82 may be programmable in order to vary the operational control of the various components.

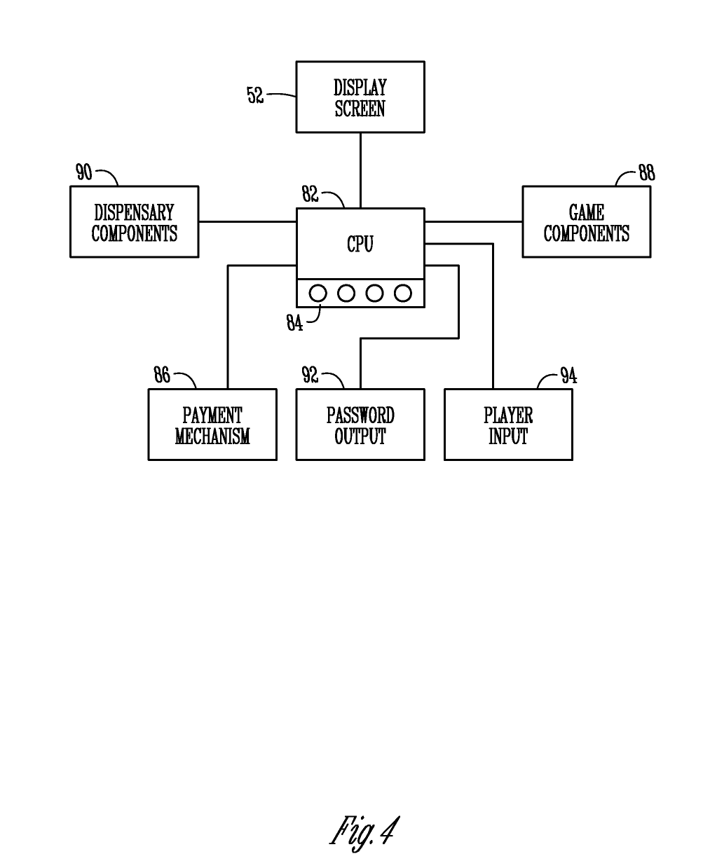

FIG. 4 is a schematic showing of the various components that interact with the computer processor 82. The computer processor 82 has a connection to receive input from and provide output to the various game components, which are indicated as a single component 88 in FIG. 4, but may be numerous components with numerous connections in practice. The game components 88 may include, for example, various light and sound controllers, and memory and logic components that communicate game status information, such as credits remaining, points scored, and a cumulative jackpot. The connection between the computer processor 82 and the game components 88 may be hard wiring that transmits electrical signals between the computer processor 82 and the game components 88, or may be other known communication connections, such as infrared or radio frequency. Those of skill in the art will be aware of numerous game components 88, as well as numerous mechanisms for connecting the game components 88 with a computer processor 82.

A payment mechanism 86 is connected with the computer processor 82 either directly or indirectly. The payment mechanism 86 may include the currency intake 40, the coin intake 36, a card reader (not shown) or other mechanism for receiving and verifying payment. The computer processor 82 who communicates with the game component 88 so that as payment is received through the payment mechanism 86, game credits corresponding to the amount of payment received are recorded and acknowledged in the game.

The computer processor 82 is also connected directly or indirectly with the dispensing components 90 such that the computer processor 82 can be used to control the dispensing process. For example, the price of the various prizes may be set, or modified, by an operator using the input device 84 associated with the computer processor 82. The computer processor 82 may be used to verify that a player attempting to cash in points accumulated during game play has accumulated a sufficient number of points for a selected prize. If so, the computer processor 82 can send a signal that ultimately results in the prize being dispensed by the dispensing components 90. The computer processor 82 may also reflect a balance or surplus of points remaining after such a “purchase” of a prize has occurred.

The computer processor 82 will provide a password to a player via the password output 92. The password output 92 according to one embodiment is a printer that prints a receipt. The receipt will include on it a password. The password may then be used by a player at a later time to access the points accumulated in an earlier game session, but not yet used to purchase a prize. The computer processor 82 includes a storage medium that includes a file that associates the password with the number of accumulated points remaining at the end of the game session. For example, the file could be a data file. The password output 92 could be a temporary visual display on a video screen. Alternatively, the password output 92 might be a printer that prints a bar code, or other machine readable item, such that a player can use the machine readable device when returning to the machine to play the game, or redeem earlier accumulated points. A player input 94 is also associated with the computer processor 82. The player input 94 permits a player to interact with and provide information to the computer processor 82. For example, the player input 94 might be a touch key pad that permits a player to input a password, or to make selections from the available prizes that can be dispensed.

A display screen 52 is attached to the computer processing unit 82 so that an operator can see output from the computer processor 82. Preferably the spray screen 52 is the same one as is used in playing the game. Alternatively, a separate display screen may be provided internally within the cabinet 12.

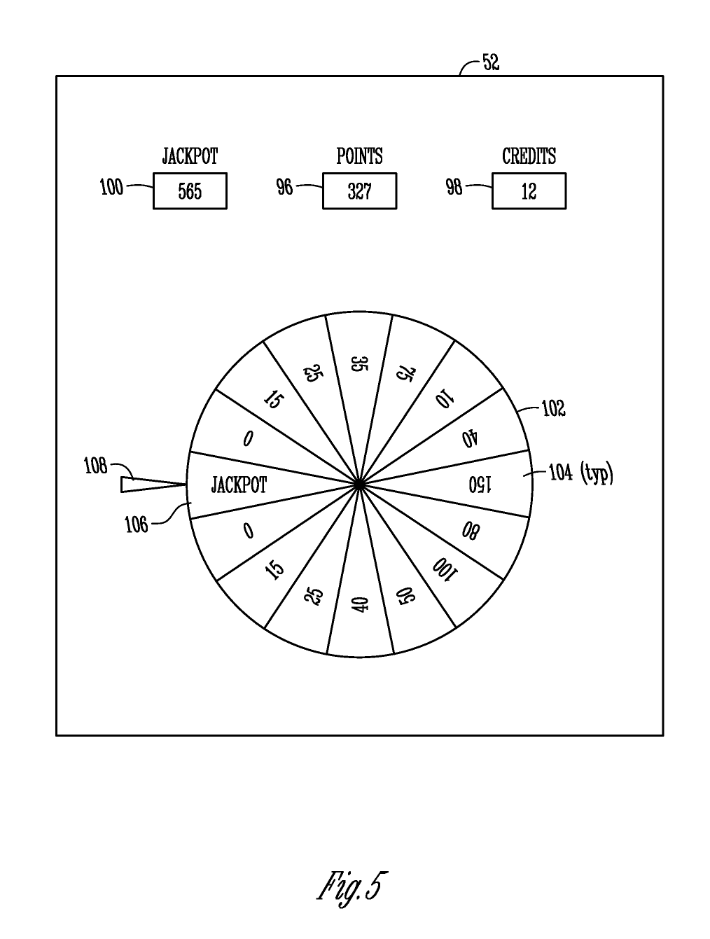

FIG. 5 shows a display screen 52 as it looks when a player has won a chance to add to or win the jackpot according to one embodiment of the invention. In this mode, the screen 52 includes a points display 96 for displaying the total number of points the player has accumulated. This point total may reflect points accumulated in the current game session, as well as points accumulated and retained from earlier game sessions. The video display 52 also includes a display of the remaining credits 98 that a player can access. According to the preferred embodiment, each credit will correspond to a single dropped coin or token. So that if a player has 12 credits reflected in the credit display 98, that means a player will be entitled to drop 12 more coins without inserting any further payment. The display of FIG. 5 also includes a jackpot indication 100. The jackpot, according to a preferred embodiment, is a cumulative total of points that may be won by a player. The jackpot is associated with the machine, and carries over from game session to game session until it is won.

The video display of FIG. 5 is used when a player has won a chance to add to or win the jackpot. According to the embodiment shown, the mechanism for determining whether a player has won the jackpot or has added points to the jackpot is a virtual jackpot wheel 102 shown on the video screen 52 that includes wedges 104 that each have a point value associated with them. According to the preferred embodiment, one of the wedges is a jackpot wedge 106. A pointer 108 is used to indicate and point at one of the wedges 104 or 106. A player may activate the wheel to spin by, for example, pressing button 26 (see FIG. 1). The computer processor (see FIG. 4) will send the appropriate signal to the video screen 52 to make the wheel 102 appear to rotate, and eventually come to rest with the pointer 108 pointing at one of the wedges 104. If the pointer 108 points at a wedge 104 that includes a point value, that point value will be added to the cumulative jackpot that is displayed in the jackpot display 100. If the wheel 102 appears to come to rest with the pointer 108 pointing at the jackpot wedge 106, a player will be credited with all the points remaining in the jackpot, and those points will be added to the points displayed in the points display 96. The jackpot will then be reduced to a minimum starting amount, and the jackpot display 100 will be revised to display that minimum amount. Preferably the minimum amount of the jackpot will be greater than zero, such that players are enticed to play the game in hopes of winning the jackpot, even if the jackpot was won in a recent game session. Preferably, the computer will randomly select which wedge 104 the pointer 108 points towards. Also, preferably the chances of any wedge being the wedge pointed to will correspond with the size of the wedge 104 relative to the size of the wheel 102. Other similar, or different mechanisms for randomly selecting point values to add to the jackpot, and for winning the jackpot may be used.

### Play of the Game by a Player

A player wishing to play the game will insert some sort of payment, for example, inserting currency into the currency intake 40, inserting coins or tokens into the coin slots 36, or by utilizing some other form of payment, such as a magnetized card inserted into a card reader. The player will then be awarded a number of credits, corresponding to the number of plays or drops of a coin that the player can initiate. The number of credits purchased will appear on the video screen 52 within a credit display field 98. A player that has credits remaining may drop a coin by pressing the play button 26. This will cause a coin 48 to be released from the coin release location 70 and slide or roll down ramp 54. A player may attempt to direct the path of the coin 48 as it falls by controlling wipers 58 with control 28. The coin 48 may also be deflected by bumpers 56 as it falls. Eventually, the coin will fall onto reciprocating plate 44. The addition of the released coin onto the oscillating plate 44 may result in one or more coins 48 falling off of plate 44 onto plate 46, and from the players perspective hopefully over ledge 78. For each coin that falls over ledge 78, a player may be awarded a point or points. According to the preferred embodiment, each coin that falls over ledge 78 results in the award of one point. The total points accumulated by a player are displayed on the video screen 58 in a points display field 96.

According to the preferred embodiment, the game also includes a cumulative jackpot feature. According to the accumulative jackpot feature, a number of points are retained in a jackpot that is associated with the machine 10, and accumulates over a number of game sessions until the jackpot is won. The amount of the jackpot is displayed on the video screen 52 in a jackpot display field 100. If a player wins the jackpot, the jackpot points are added to the player's accumulated points and the new total of accumulated points is displayed in the points field 96. The jackpot will be reset to a starting level, that is preferably greater than zero so that there is always some amount of jackpot available to win.

According to the embodiment shown, a player earns a chance to win the jackpot when one of the released coins 48 falls through moving target 62. During a game session, the moving target 62 moves back and forth across the playing field within slot 63. When a coin 48 passes through moving target 62 as it falls, a player is awarded a chance to win the jackpot using the screen shown in FIG. 5 that will appear on the video screen 52. From this screen, a player can activate the video jackpot wheel 102 by pressing button 26. Alternatively, the activation of the jackpot wheel 102 may occur automatically upon the player earning a chance to win the jackpot. If the jackpot wheel 102 comes to rest with the pointer 108 pointing at the jackpot wedge 106, the player will be awarded the points in the jackpot. If the jackpot wheel 102 comes to rest with the pointer 108 pointing at one of the other wedges 104, the points indicated within that wedge will be added to the cumulative jackpot total and the jackpot total in the jackpot display 100 will be updated to reflect the new total.

A released coin 48 will also fall through one of the stationary targets 60 before it lands on the oscillating plate 44. According to the preferred embodiment, one or more of the several stationary targets 60 may be illuminated at any one time. If the dropped coin falls through one of the stationary targets 60 that has been illuminated, the player may earn an additional bonus. This bonus may be provided in the form of additional credits for coins the player can release as desired, or in the form of bonus coins that are automatically dispensed from the release location 70 by the machine. According to a preferred embodiment, the number of credits or coins earned for passing through an illuminated stationary target 60 may be between 3 and 7.

When a player has exhausted all of their credits, the player may insert additional payment to obtain additional credit 15, and then continue playing the game session. Alternatively, the player may choose to redeem the accumulated points for merchandise or prizes contained within the merchandise compartments 14 and 16, or the player may choose to save the points for a better gaming session.

### Redeeming Points for Merchandise

If a player wishes to redeem accumulated points for merchandise, the player will use the key pad 30 to indicate that the player is redeeming points for merchandise, and to select the particular piece of merchandise to be dispensed by the dispenser 18. Once a player makes a selection for merchandise to be vended, the merchandise will be dispensed, which the player may retrieve through the prize doors 32. If the merchandise selected was assigned a value that was less than the total points accumulated by the player, the player may have points remaining, which can be redeemed for additional merchandise if the player has sufficient points.

### Saving Accumulated Points

If a player has accumulated points remaining at the end of a gaming session, either because the player did not redeem the points for merchandise or because the player had points remaining after redeeming some of the points on merchandise, the player may have the machine 10 issue a unique password that the player can use for a later gaming session so that the points will be carried over. Using the keypad 30, the player can indicate the player's desire to carry the points over. When this happens, the receipt outlet 42 will provide a printed receipt to the player that includes a password. Preferably, the printed receipt will also include an indication of the location and particular machine, as well as a date and time. This password will be associated with the accumulated points remaining at the end of the game session, such that when a player enters the pass code during a later game session at the same machine 10, the accumulated points associated with that password will be added to the accumulated points of the later game session. Preferably, a player may be able to enter several passwords in order to accumulate points from several past game sessions into a single accumulated points total. This will permit a player to continue accumulating points until t hey have earned enough to purchase desired merchandise from the attached dispenser. For example, a player may attempt over several sessions to accumulate enough points to redeem them for the grand prize, which in the preferred embodiment is retained within grand prize compartment 16. The computer processor 82 associates the accumulated points with a randomly generated password. According to a preferred embodiment, the password is a series of ten digits that are randomly generated based upon the date and time at which the password is associated with the point total. Therefore, because the method for generating the random password is dependent upon the date and time, each password will be unique. It should be understood that a player may initiate a game session simply by entering a password in order to redeem accumulated points from one or more previous game sessions without entering any new payment into the machine 10, and without actually releasing any more coins to play the game. According to another embodiment, in addition to the points being associated with the password, remaining credits could also be associated with the password, such that a player wishing to terminate the game session without exhausting all of their credits might be able to do so and return to the machine at a later time to finish exhausting the credits. It should also be understood that it may be possible to link more than one machine together over a computer network, such that a player need not return to the exact same machine in order to take advantage of the carried over points. Furthermore, it should be understood that the password may by any sequence of letters, numbers, or symbols, or may be a machine readable code, such as a bar code.

### Operator Control Features

An operator of the machine 10, such as the owner of an establishment that includes one or more of the machines 10, can customize some of the features. For example, using the computer input 84 an operator may assign various point values to the various merchandise that can be dispensed. Naturally, more valuable prizes will be assigned higher point totals, and lower value prizes will be assigned lower point totals. Preferably, the operator may associate the points with a particular monetary value, such that the operator can easily determine how many points to set for the redemption value of a prize based on the cost of the prize to the operator. The point value assigned to the prize will vary according to the amount of markup desired by the operator, as well as the payout rate for points in relation to purchased credits. The display screen 52 can be converted into an operator mode wherein the display screen 52 shows various menus and displays that relate to control of the machine 10. One of the displays should be a control screen and/or menu for the dispenser.

The computer processor 82 and display screen 52 should also include a menu in the operator mode for controlling the payout rate. For example, if an operator wishes for the play of the game to on average result in a player winning 30 points for every one dollar paid, that can be accomplished. The payout rate can be roughly controlled by the size of the starting jackpot, and by the relative size of the jackpot wedge 106 within the jackpot wheel 102. To increase the payout percentage, an operator can increase the starting amount for the accumulative jackpot, and can increase the relative size of the jackpot wedge 106, such that a user will more often win the jackpot on the those instances when the player has won a chance at the jackpot. To decrease the payout rate, an operator can decrease the relative size of the jackpot wedge 106, such that the frequency of winning the jackpot upon earning a chance at winning the jackpot is decreased. Similarly, by decreasing the starting amount in the jackpot after a jackpot has been won, the overall payout rate will be reduced.

According to one feature of the present invention, the computer processor 82 can produce reports that can be seen on display screen 52 that show a record of the payments that have been received by the machine 10 as well as the number of points awarded by the machine 10, such that an operator can determine whether the relative payout rate in points matches a desired level.

The invention has been shown and described above with the preferred embodiments, and it is understood that any modifications, substitutions, and additions may be made which are within the intended spirit and scope of the invention.

What is claimed is:

1. A combination game and prize dispenser comprising:
a game, wherein a player of the game can accumulate points;
a visual display that displays points accumulated by the player;
a dispenser including a plurality of prizes, the dispenser adapted to dispense a selected prize in exchange for accumulated points;
a mechanism that issues a password to the player, the password being associated with points accumulated during a first game session that have not yet been exchanged for a prize; and
an input device for inputting the password such that the points associated with the password can be added to the player's points in a second game session that occurs after the first game session.

2. The combination of claim 1, wherein the mechanism that issues a password is a printer that prints a written receipt that shows the password.

3. The combination of claim 2, wherein the printer also prints a date and time on the receipt.

4. The combination of claim 1, wherein the input device is a keypad.

5. The combination of claim 1, wherein the game is a pusher game wherein the player accumulates points based on a number of coins that are pushed over a ledge; and further wherein the combination comprises a payment receiving mechanism.

6. The combination of claim 5, wherein the combination includes a visual display of a cumulative jackpot, the jackpot being a number of points that builds over consecutive game sessions until it is won, and further wherein play of the game can result in the player receiving a chance to win the jackpot.

7. The combination of claim 6, further comprising a control that can be accessed by an operator to vary a percentage of the chance to win the cumulative jackpot in order control an average amount of points accumulated in proportion to an amount of payment received.

8. The combination of claim 7, wherein the chance to win the cumulative jackpot is determined by a spin of a video wheel with wedges corresponding to various point amounts and at least one wedge that results in a win of the jackpot, and further wherein control of the percentage of the chance to win the cumulative jackpot is accomplished by varying a relative size of the at least one wedge that results in a win of the jackpot.

9. The combination of claim 1, wherein the game comprises:
a dispensing mechanism for dropping coins;
a triggering device for activating the dispensing mechanism to drop a coin;
a controllable obstacle for affecting a path of a dropped coin as it falls from the dispensing mechanism;
a moving bonus target, wherein if a dropped coin falls through the moving bonus target a player earns a bonus; and
a plurality of stationary bonus targets that can be illuminated, wherein if a dropped coin falls through an illuminated stationary bonus target, a player earns an additional bonus.

10. A coin pusher game, the game comprising:
a release mechanism for dropping coins;
a triggering device for activating the release mechanism to drop a coin;
a controllable obstacle for affecting a path of a dropped coin as it falls from the dispensing mechanism;
a moving bonus target, wherein if a dropped coin falls through the moving bonus target a player earns a bonus; and
a plurality of stationary bonus targets that can be illuminated, wherein if a dropped coin falls through an illuminated stationary bonus target, the player earns an additional bonus.

11. The coin pusher game according to claim 10, further comprising:
a visual display that displays points accumulated by the player;
a dispenser including a plurality of prizes, the dispenser adapted to dispense a selected prize in exchange for accumulated points;
a mechanism that issues a password to the player, the password being associated with points accumulated during a first game session that have not yet been exchanged for a prize; and
an input device for inputting the password such that the points associated with the password can be added to the player's points in a second game session that occurs after the first game session.

12. The coin pusher game of claim 11, further comprising visual display of a cumulative jackpot, the jackpot being a number of points that builds over consecutive game sessions until it is won, and further wherein the bonus is a chance to win the cumulative jackpot.

13. The coin pusher game of claim 12, further comprising a control that can be accessed by an operator to vary a percentage of the chance to win the cumulative jackpot in order control an average amount of points accumulated in proportion to an amount of payment received by the game.

14. The coin pusher of claim 13, wherein the chance to win the cumulative jackpot is determined by a spin of a video wheel with wedges corresponding to various point amounts and at least one wedge that results in a win of the jackpot, and further wherein control of the percentage of the chance to win the cumulative jackpot is accomplished by varying a relative size of the at least one wedge that results in a win of the jackpot.

15. The coin pusher game of claim 14, further comprising a data storage medium for recording points accumulated and for providing a report to an operator of the number of points accumulated over a period of time.

16. The coin pusher game of claim 10 further comprising:
a mechanism that issues a password to the player, the password being associated with points accumulated during a first game session that have not yet been exchanged for a prize; and
an input device for inputting the password such that the points associated with the password can be added to the player's points in a second game session that occurs after the first game session.

17. A pusher game and merchandise dispenser combination comprising:
a cabinet;
a pusher game disposed within the cabinet, the pusher game being of the type wherein a player accumulates points based on coins being pushed over a ledge; and
a merchandise dispenser disposed within the cabinet, the dispenser adapted to dispense a selected prize in exchange for accumulated points.

18. The combination of claim 17, wherein the coins remain within the cabinet and are not dispensed to the player.

19. The combination of claim 17, further comprising:
a mechanism that issues a password to the player, the password being associated with points accumulated during a first game session that have not yet been exchanged for a prize; and
an input device for inputting the password such that the points associated with the password can be added to the player's points in a second game session that occurs after the first game session.

20. The combination of claim 19, further comprising:
a visual display of a cumulative jackpot, the jackpot being a number of points that builds over consecutive game sessions until it is won, and wherein play of the game can result in the player receiving a chance to win the cumulative jackpot;
a control that can be accessed by an operator to vary a percentage of the chance to win the cumulative jackpot in order control an average amount of points accumulated in proportion to an amount of payment received by the game.

21. The combination claim 20, wherein the chance to win the cumulative jackpot is determined by a spin of a video wheel with wedges corresponding to various point amounts and at least one wedge that results in a win of the jackpot, and further wherein control of the percentage of the chance to win the cumulative jackpot is accomplished by varying a relative size of the at least one wedge that results in a win of the jackpot.
